(19) United States
(12) Patent Application Publication
(10) Pub. No.: US 2002/0063233 A1
(43) Pub. Date: May 30, 2002

(54) Plastic-bonded permanent magnet and process for producing a plastic-bonded permanent magnet

(75) Inventor: Martin Schmidt, Erlangen (DE)

Correspondence Address: BAKER BOTTS LLP, 44TH FLOOR, 30 ROCKEFELLER PLAZA, NEW YORK, NY, 10112-4498, US

(73) Assignee: Siemens Aktiengesellschaft

(21) Appl. No.: 09/848,687

(22) Filed: May 3, 2001

(30) Foreign Application Priority Data
Nov. 24, 2000 (DE) 100 583 93.8

(51) Int. Cl. H01F 1/00

(52) U.S. Cl. 252/62.54; 252/299.01

(57) ABSTRACT

Plastic-bonded permanent magnets which are produced from a homogenous mixture of liquid crystal polymer and strontium ferrite have significantly improved magnetic properties and can be used at significantly higher temperatures than has previously been possible. The injection-molding process is used to produce plastic-bonded permanent magnets of this type.

### FIELD OF THE INVENTION

The invention relates to a plastic-bonded permanent magnet and to a process for producing a plastic-bonded permanent magnet.

Hitherto, epoxy resin, PAx (e.g. PA12, etc.), PPS, etc. have been used as the plastic base for plastic-bonded permanent magnets and these materials have been mixed with a suitable magnetic material.

One drawback of these materials which has emerged is that a very high coefficient of linear thermal expansion restricts the use of permanent magnets consisting of these materials to a relatively narrow temperature range (up to at most approximately 140° C.). In addition, the magnetic field strengths which can be achieved in the resulting magnets are not optimal on account of the fact that, because of the materials used, the maximum possible degree of filling of the polymer binders with magnetizable materials is relatively low.

It is an object of the invention to provide a plastic-bonded permanent magnet with a low coefficient of linear thermal expansion and improved magnetic properties and to specify a process which allows the properties of the substances used to be combined well when producing a permanent magnet of this type.

According to the invention, for a plastic-bonded permanent magnet of the type described in the introduction, this object is achieved in such a way that this magnet substantially comprises a magnetic mixture of liquid crystal polymer and ferrite.

A first advantageous embodiment of the invention is characterized in that at least some of the ferrite used is strontium ferrite.

The physical and magnetic properties of strontium ferrite make it possible to achieve a very low coefficient of linear thermal expansion (in the range of that of metals) of the mixture, which widens the temperature range for permanent magnets produced from materials of this type to up to 220° C.

In this context, it has proven advantageous for the strontium ferrite to be present in a concentration of 40-45%. On account of the crystalline structure of strontium ferrite, it can be assumed that said concentration leads to a significant improvement in the magnetic properties of the mixture, which allows permanent magnets produced from materials of this type to be used even for precision measurements.

A process for producing a plastic-bonded permanent magnet is characterized in that liquid crystal polymer and strontium ferrite are joined together in an injection-molding operation, and this is followed by magnetization by means of at least one external magnetic field. The result is a high degree of homogeneity of the mixed material.

An exemplary embodiment of the invention is illustrated in the drawing and explained in more detail below. In the drawing:

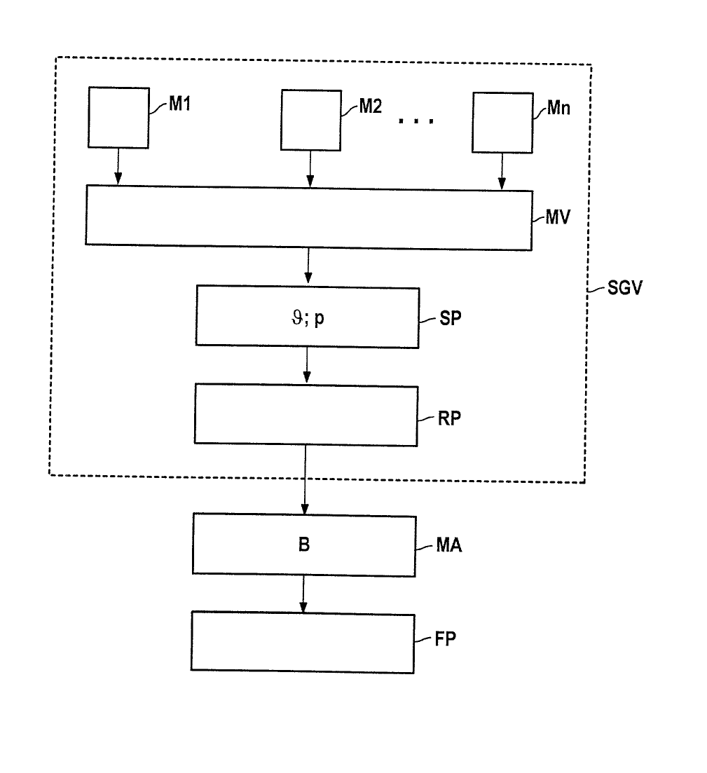

FIG. 1 shows the production of a plastic-bonded permanent magnet by means of the injection-molding process.

The illustration shown in FIG. 1 uses a flow diagram to depict the production of a plastic-bonded permanent magnet using an injection-molding process. The materials provided for this purpose (first material M1, for example liquid crystal polymer, second material M2, for example strontium ferrite, up to n-th material Mn) are introduced and mixed in a mixing device MV with a defined mixing ratio (in the case of three materials, for example, in the ratio 25:70:5), as indicated by arrows which lead from the materials M1 to Mn to the mixing device MV. The mixture formed in this way is then converted, in a transfer-molding operation SP at temperature θ and pressure p, to form a blank product RP (as indicated by arrows which lead from the mixing device MV to the transfer molding device SP and from there to the blank product RP). The blank product RP is an as yet unmagnetized magnet. The steps described above are integrated into an injection-molding device SGV, as indicated by dashed lines. In a subsequent process step, the blank product RP which has been formed is exposed to at least one external magnetic field B in a magnetization device MA and is magnetized as desired, resulting in the finished product FP, i.e. the permanent magnet itself. This is also illustrated by arrows, which lead from the blank product RP to the magnetization device MA and from there to the finished product FP.

1. A plastic-bonded permanent magnet, characterized in that it substantially comprises a magnetizable mixture of liquid crystal polymer (M1) and ferrite (M2).

2. The plastic-bonded permanent magnet as claimed in claim 1, characterized in that at least some of the ferrite used is strontium ferrite.

3. The plastic-bonded permanent magnet as claimed in claim 2, characterized in that the strontium ferrite is present in a concentration of 40-45%.

4. A process for producing a plastic-bonded permanent magnet, characterized in that liquid crystal polymer (M1) and strontium ferrite (M2) are joined together in an injection-molding operation, and this is followed by magnetization by means of at least one external magnetic field (B).
